(19) United States
(12) Patent Application Publication
(10) Pub. No.: US 2006/0007843 A1
(43) Pub. Date: Jan. 12, 2006

(54) Optical recording material and optical recording medium

(75) Inventors: Junji Tanabe, Tokyo (JP); Atsushi Monden, Tokyo (JP); Masahiro Shinkai, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/102,712

(22) Filed: Apr. 11, 2005

(30) Foreign Application Priority Data
Apr. 21, 2004 (JP) P2004-126094
Apr. 21, 2004 (JP) P2004-126098

(51) Int. Cl. G11B 7/00

(52) U.S. Cl. 369/272.1; 369/100

(57) ABSTRACT

An optical recording material used in an optical recording medium capable of recording information by irradiation of light, which comprises a cation represented by general formula (1a) below and a chelate compound of an azo compound and a metal, the content ratio of the chelate compound being 10 to 70 mole percent based on the total of the cation and the chelate compound, 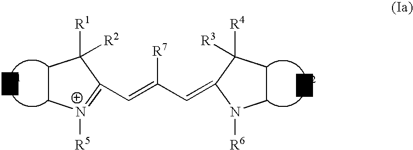
wherein R¹, R², R³, R⁴, R⁵ and R⁶ each independently represent C1-4 alkyl, etc., R⁷ represents hydrogen, etc. and Q¹ and Q² each independently represent a group of atoms constituting a benzene ring, etc., with the proviso that at least one from among R¹, R², R³ and R⁴ is a non-methyl group.

### BACKGROUND OF THE INVENTION

1. Field of the Invention

The present invention relates to an optical recording medium for recording of information by irradiation of light, and to an optical recording material used for it.

2. Related Background of the Invention

Optical recording discs such as CD-R (CD-Recordable) and DVD-R (DVD-Recordable) media are widely popular as optical recording media. Increasingly higher recording densities require shorter wavelengths for the recording and reading light. The current recording/reading wavelength for CD-Rs, for example, is 780 nm, but the next-generation CD-R and DVD-R media use wavelengths as short as 635 to 680 nm. Hitherto known dyes used in optical recording media suitable for such short wavelengths include cyanine dyes (see Japanese Unexamined Patent Publication HEI No. 11-34499), and so-called “metal-containing azo dyes” which are chelate compounds of azo compounds and metals (see Japanese Unexamined Patent Publication HEI No. 9-323478).

### SUMMARY OF THE INVENTION

Optical recording media are also being sought which have faster recording speeds, in addition to shorter wavelengths as mentioned above. Higher sensitivity dyes may be used to achieve higher speeds, but higher dye sensitivity tends to result in increased jitter of the reading signal in the time direction. Increasing speeds in the future will make it even more difficult to maintain satisfactory levels of both sensitivity and jitter with conventional dyes.

It is an object of the present invention, which has been accomplished in light of the circumstances described above, to provide an optical recording medium which achieves sufficiently high sensitivity without significant increase in jitter, as well as an optical recording material used for the medium.

In order to achieve the object stated above, the present invention provides an optical recording material used for an optical recording medium capable of recording information by irradiation of light, which comprises a cation represented by general formula (1a) below and a chelate compound of an azo compound and a metal, the content ratio of the chelate compound being 10 to 70 mole percent with respect to the total of the cation and the chelate compound.

The invention further provides an optical recording medium capable of recording information by irradiation of light, which comprises a cation represented by general formula (1a) below and a chelate compound of an azo compound and a metal, the content ratio of the chelate compound being 10 to 70 mole percent with respect to the total of the cation and the chelate compound.

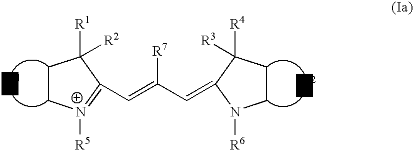

In this formula, R¹ and R² each independently represent C1-4 alkyl or optionally substituted benzyl, or a group linked together to form a 3- to 6-membered ring, R³ and R⁴ each independently represent C1-4 alkyl or optionally substituted benzyl, or a group linked together to form a 3- to 6-membered ring, R⁵ and R⁶ each independently represent C1-4 alkyl or aryl, R⁷ represents hydrogen, a halogen, cyano, optionally substituted C1-4 alkyl or optionally substituted aryl and Q¹ and Q² each independently represent a group of atoms constituting an optionally substituted benzene ring or an optionally substituted naphthalene ring, with the proviso that at least one from among R¹, R², R³ and R⁴ is a non-methyl group.

The optical recording material of the invention, or an optical recording layer of an optical recording medium of the invention, employs a cation having the specific structure described above as the dye, which is combined with the chelate compound in the specific proportion mentioned above, in order to achieve excellent jitter resistance along with satisfactory sensitivity even at high recording speeds.

The optical recording material of the invention is preferably obtained by mixing a salt composed of the aforementioned cation and its counter anion with the aforementioned chelate compound. The optical recording layer of an optical recording medium of the invention preferably comprises a mixture obtained by mixing a salt composed of the aforementioned cation and its counter anion with the aforementioned chelate compound.

Since the optical recording material and optical recording medium are obtained by merely mixing two or more different materials, they can be manufactured more efficiently. The optical recording material and optical recording medium obtained by such mixing will comprise at least the cation and its counter anion, and in some cases will include the counter cation of the chelate compound. Such counter anions and counter cations have conventionally constituted impurities which have impaired the stability of the optical recording material quality. However, the present inventors have found that this drawback does not readily occur in the optical recording material and optical recording medium of the invention which comprises the aforementioned specific dye combination.

The invention also provides an optical recording material used for an optical recording medium capable of recording information by irradiation of light, which comprises a cation represented by general formula (1b) below, a chelate compound of an azo compound and a metal, and a compound represented by general formula (2) below.

The invention further provides an optical recording medium which includes a recording layer comprising a cation represented by general formula (1b) below, a chelate compound of an azo compound and a metal, and a compound represented by general formula (2) below.

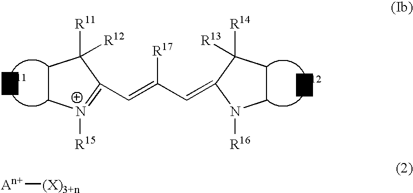

In these formulas, R¹¹, R¹², R¹³, R¹⁴, R¹⁵ and R¹⁶ each independently represent optionally substituted C1-4 alkyl or optionally substituted aryl, R¹⁷ represents hydrogen, a halogen, cyano, optionally substituted C1-4 alkyl or optionally substituted aryl, Q¹¹ and Q¹² each independently represent a group of atoms constituting an optionally substituted aromatic ring, A represents a nitrogen or phosphorus atom, X represents hydrogen, optionally substituted C1-4 alkyl or optionally substituted aryl and n represents 0 or 1, with the proviso that R¹¹ and R¹² or R¹³ and R¹⁴ may be linked together as a group forming a cyclic structure, at least one from among R¹¹, R¹², R¹³ and R¹⁴ is a non-methyl group, and multiple X groups in the same molecule may be the same or different, with at least one of the X groups in the same molecule representing optionally substituted C1-4 alkyl or optionally substituted aryl.

In an optical recording material of the invention, or an optical recording layer of an optical recording medium of the invention, adequate sensitivity is exhibited and jitter is satisfactorily prevented by the presence of the cation represented by general formula (1b) and the chelate compound of an azo compound and a metal, in combination with the specific compound represented by formula (2). In particular, it is possible to achieve a sufficiently satisfactory level of both sensitivity and jitter even at the high recording speeds which conventionally have caused difficulties for practical use.

Because adding a compound represented by formula (2) to the recording layer of an optical recording medium has tended to lead to lower sensitivity or deterioration of the material adjacent to the recording layer, it has been the conventional wisdom that recording layers should not contain such compounds. However, the present inventors have discovered that adding a compound represented by formula (2) in a system comprising the aforementioned specific cation as the dye notably improves the dye sensitivity while sufficiently inhibiting jitter. Although the mechanism by which this effect is exhibited has not been fully elucidated, it is conjectured that the compound represented by formula (2) produces an effect which promotes thermal decomposition of the dye, and thus results in increased sensitivity without significantly higher jitter.

The total number of carbon atoms of the compound represented by formula (2) is preferably no greater than 20. Stated differently, the total number of carbon atoms of each X in the same molecule is preferably no greater than 20. If the total number of carbon atoms exceeds 20, the concentration of the dye in the optical recording material or recording layer will be reduced when the compounds are included in an equimolar ratio, as compared to a total number of carbon atoms of 20 or less, and this will tend to prevent sufficient sensitivity.

In the cation represented by formula (1b), it is preferable that R¹¹ and R¹² each independently represent C1-4 alkyl or optionally substituted benzyl, or a group linked together to form a 3- to 6-membered ring, R¹³ and R¹⁴ each independently represent C1-4 alkyl or optionally substituted benzyl, or a group linked together to form a 3- to 6-membered ring, R¹⁵ and R¹⁶ each independently represent C1-4 alkyl or aryl, and Q¹¹ and Q¹² each independently represent a group of atoms constituting an optionally substituted benzene ring or an optionally substituted naphthalene ring. A cation having this specific structure exhibits high sensitivity by itself, while the sensitivity is synergistically enhanced by the combination with the compound represented by formula (2).

The optical recording material of the invention, or the optical recording layer of an optical recording medium of the invention, preferably also contains PF₆⁻ or SbF₆⁻ as an anion in addition to the aforementioned components, from the standpoint of facilitating optimization of the leveling factor. Some of the anions in the optical recording material and optical recording layer will normally act as counter anions to the cation represented by formula (1a) or formula (1b) to form salts.

### BRIEF DESCRIPTION OF THE DRAWINGS

FIG. 1 is a partial cross-sectional view showing an embodiment of an optical recording disc as an optical recording medium of the invention.

FIG. 2 is a partial cross-sectional view showing an embodiment of an optical recording disc as an optical recording medium of the invention.

### DESCRIPTION OF THE PREFERRED EMBODIMENTS

Preferred embodiments of the present invention will now be explained in detail, with the understanding that the invention is not limited to these embodiments.

(Optical Recording Material)

The optical recording material of the invention comprises a cation represented by general formula (1a) above (hereinafter also referred to as “trimethinecyanine dye cation 1a”) or a cation represented by general formula (1b) above (hereinafter also referred to as “trimethinecyanine dye cation 1b”), and a chelate compound of an azo compound and a metal. The cation represented by general formula (1a) or (1b) belongs to the group of cations of dyes known as trimethinecyanine dyes. The trimethinecyanine dye cation and the chelate compound can also act alone as dyes for optical recording, but according to the present invention they are used in combination.

In the trimethinecyanine dye cation 1b, R¹¹ and R¹² preferably each independently represent C1-4 alkyl or optionally substituted benzyl, or a group linked together to form a 3- to 6-membered ring, R¹³ and R¹⁴ preferably each independently represent C1-4 alkyl or optionally substituted benzyl, or a group linked together to form a 3- to 6-membered ring, R¹⁵ and R¹⁶ preferably each independently represent C1-4 alkyl or aryl, and Q¹¹ and Q¹² preferably each independently represent a group of atoms constituting an optionally substituted benzene ring or an optionally substituted naphthalene ring. In other words, the trimethinecyanine dye cation 1b is preferably the same as the trimethinecyanine dye cation 1a.

At least one from among R¹, R², R³ and R⁴ is preferably optionally substituted benzyl. Similarly, at least one from among R¹¹, R¹², R¹³ and R¹⁴ is preferably optionally substituted benzyl. Applying optionally substituted benzyl for these substituents will produce a more notable effect of jitter inhibition and sensitivity enhancement.

R⁷ and R¹⁷ are each preferably hydrogen, a halogen, cyano, C1-4 alkyl, optionally substituted phenyl or optionally substituted benzyl. Hydrogen is particularly preferred among these for R⁷ and R¹⁷.

As preferred specific examples for the trimethinecyanine dye cation 1a and the trimethinecyanine dye cation 1b there may be mentioned those shown in the following Tables 1 to 6, which may be used alone or in various combinations. These trimethinecyanine dye cations may be obtained by synthesis according to publicly known methods.

TABLE 1

| No. | |
|---|---|
| T1 | 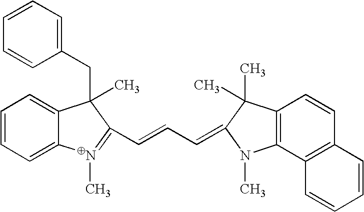 |
| T2 | 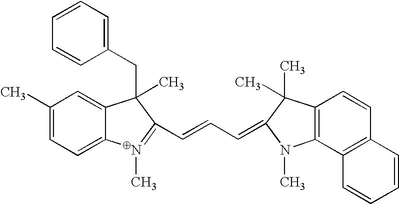 |
| T3 | 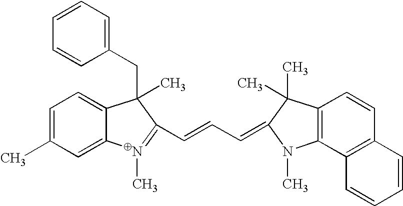 |
| T4 | 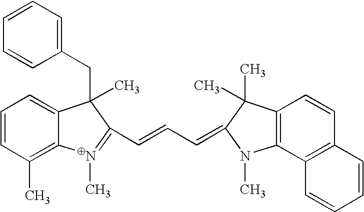 |
| T5 | 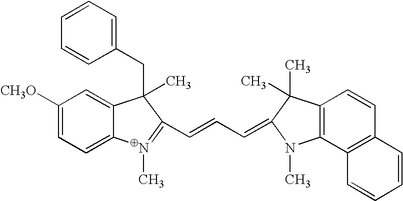 |
| T6 | 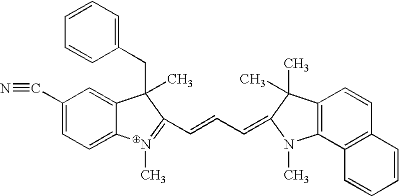 |
| T7 | 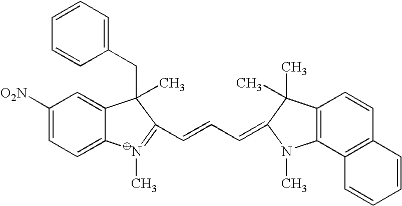 |
| T8 | 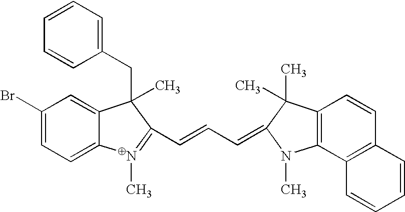 |
| T9 | 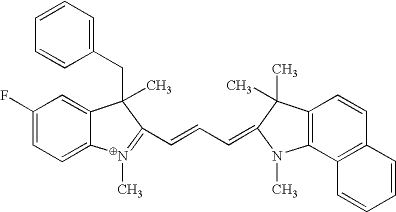 |
| T10 | 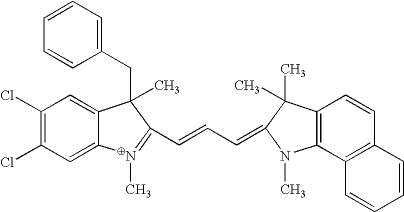 |
| T11 | 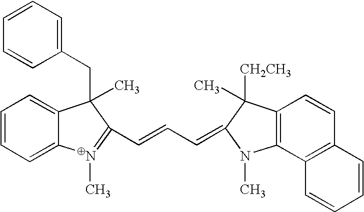 |
| T12 | 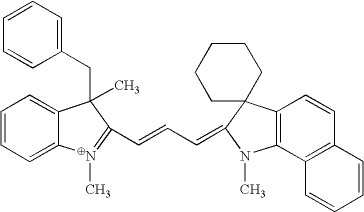 |

TABLE 2

| No. | |
|---|---|
| T13 | 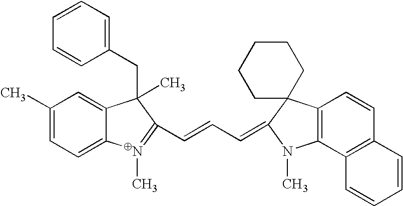 |
| T14 | 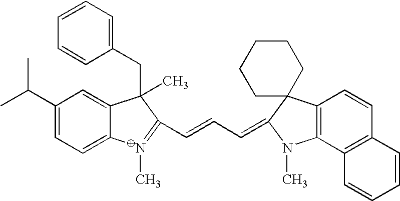 |
| T15 | 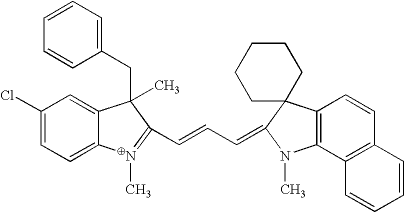 |
| T16 | 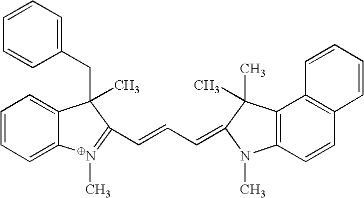 |
| T17 | 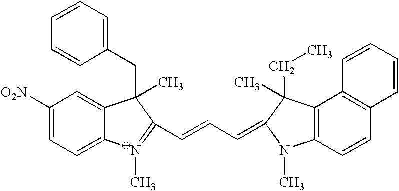 |
| T18 | 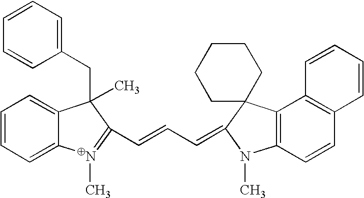 |
| T19 | 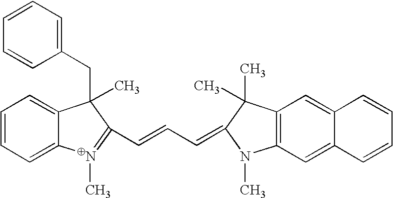 |
| T20 | 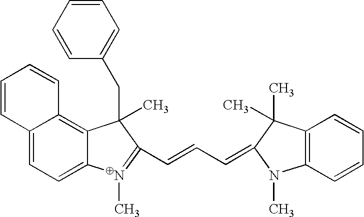 |
| T21 | 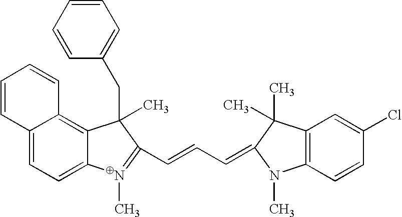 |
| T22 | 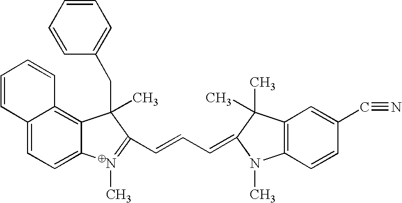 |
| T23 | 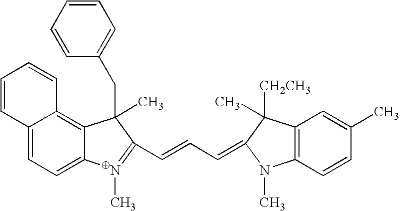 |
| T24 | 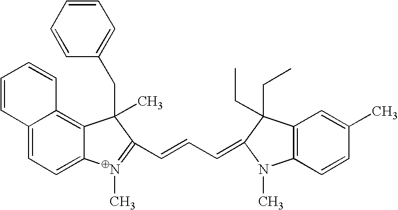 |

TABLE 3

| No. | |
|---|---|
| T25 | 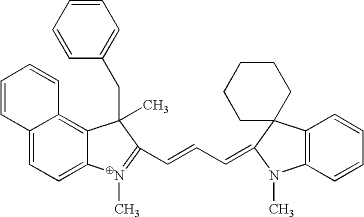 |
| T26 | 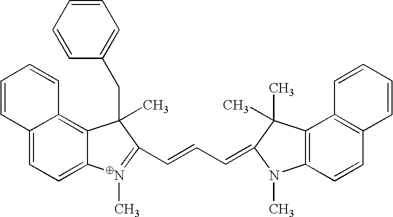 |
| T27 | 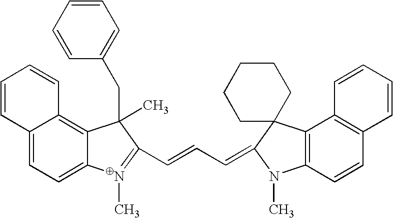 |
| T28 | 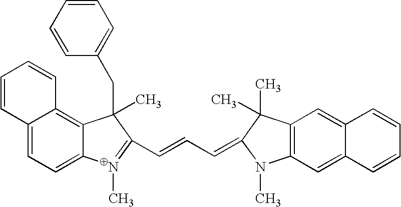 |
| T29 | 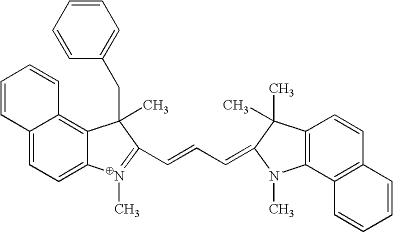 |
| T30 | 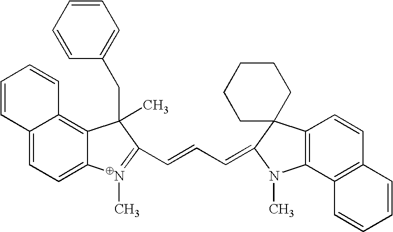 |
| T31 | 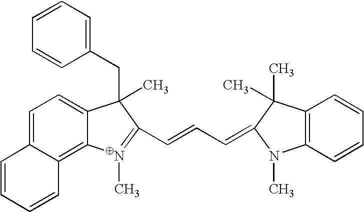 |
| T32 | 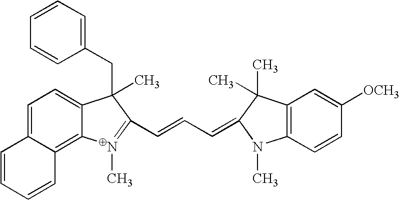 |
| T33 | 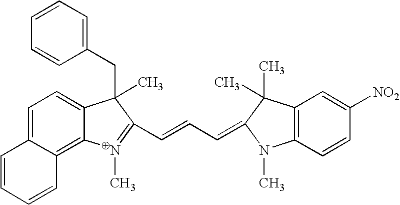 |
| T34 | 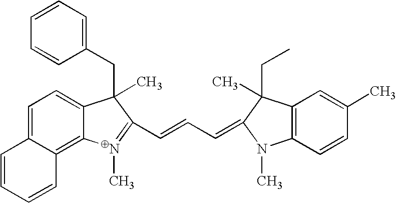 |
| T35 | 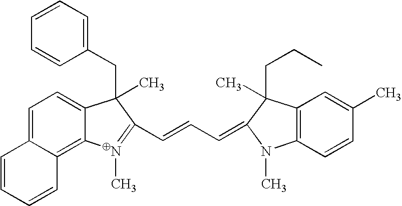 |
| T36 | 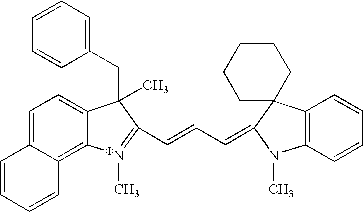 |

TABLE 4

| No. | |
|---|---|
| T37 | 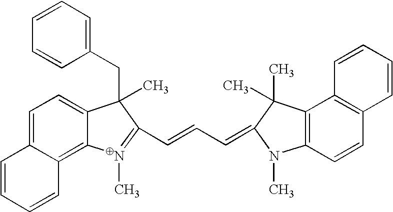 |
| T38 | 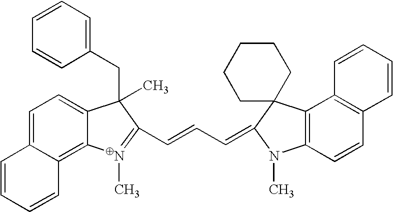 |
| T39 | 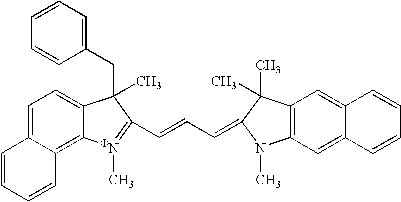 |
| T40 | 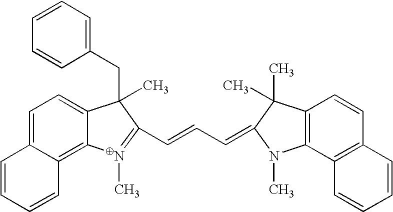 |
| T41 | 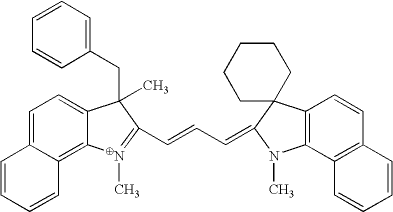 |
| T42 | 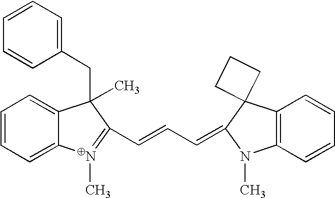 |
| T43 | 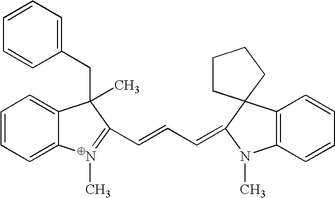 |
| T44 | 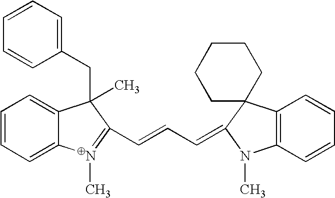 |
| T45 | 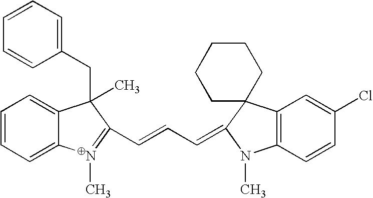 |
| T46 | 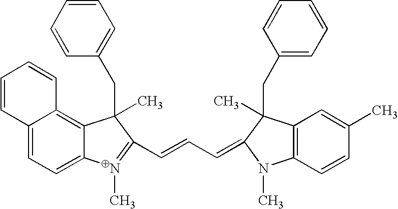 |
| T47 | 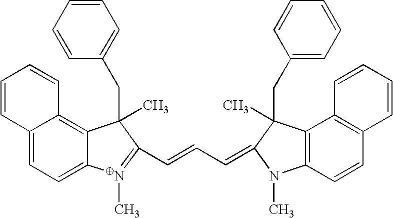 |
| T48 | 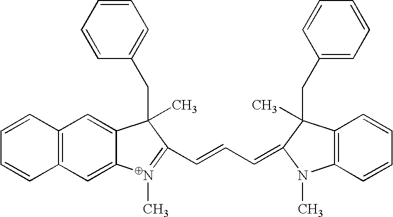 |

TABLE 5

| No. | |
|---|---|
| T49 | 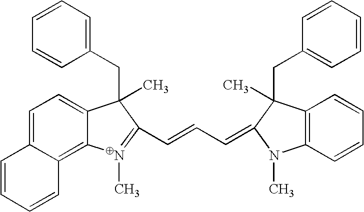 |
| T50 | 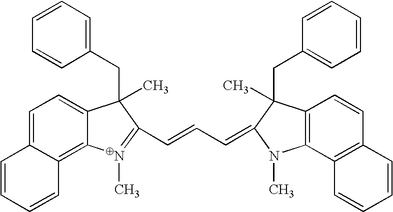 |
| T51 | 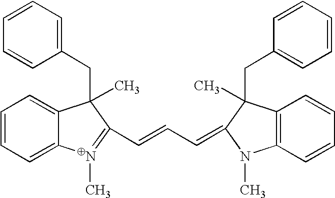 |
| T52 | 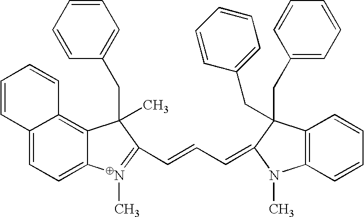 |
| T53 | 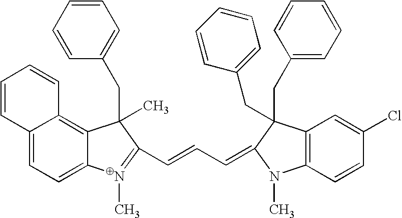 |
| T54 | 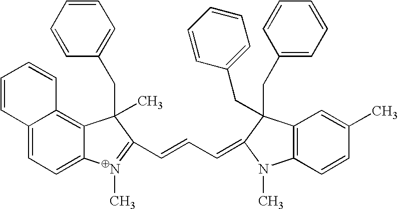 |
| T55 | 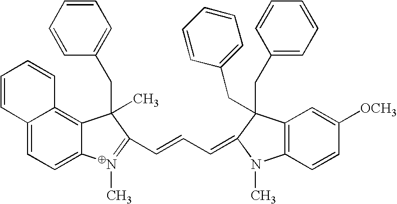 |
| T56 | 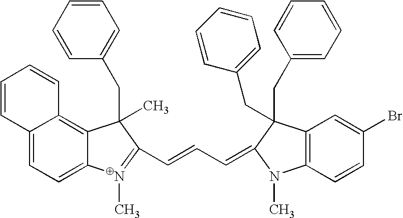 |
| T57 | 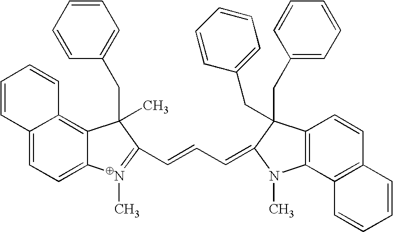 |
| T58 | 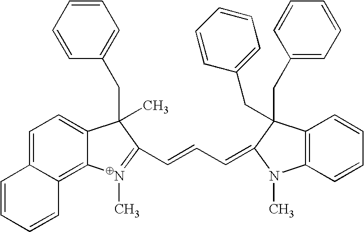 |
| T59 | 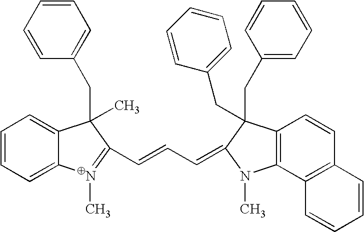 |
| T60 | 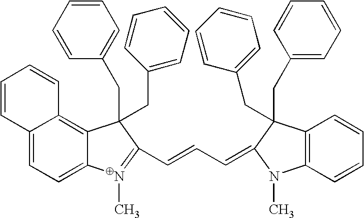 |

TABLE 6

| No. | |
|---|---|
| T61 | 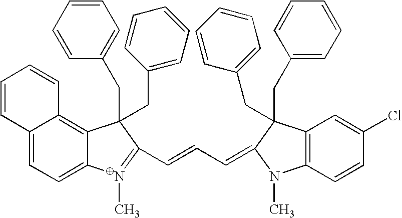 |
| T62 | 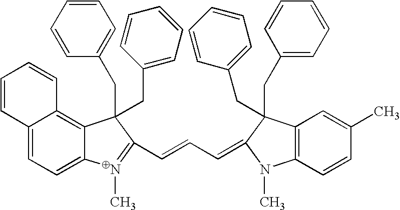 |
| T63 | 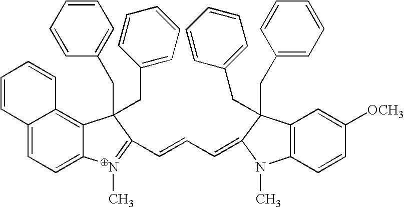 |
| T64 | 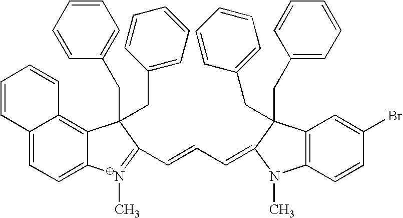 |
| T65 | 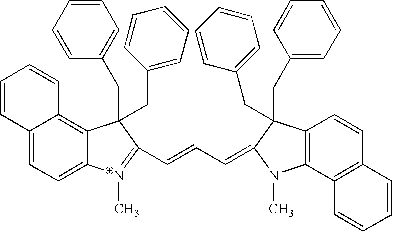 |
| T66 | 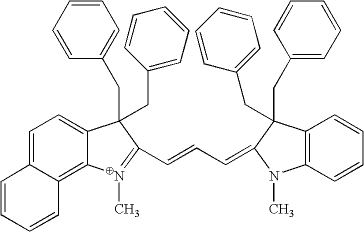 |
| T67 | 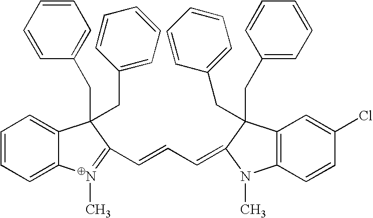 |

The optical recording material will usually contain counter anions which neutralize the charges of these trimethinecyanine dye cations. As examples of such counter anions there may be mentioned monovalent anions such as ClO₄⁻, I⁻, BF₄⁻, PF₆⁻ and SbF₆⁻. Alternatively, when the chelate compound is an anion, it may constitute the counter anion for the trimethinecyanine dye cation, with a salt being formed between the trimethinecyanine dye cation and the chelate compound. Preferred are optical recording materials containing at least one from among PF₆⁻ and SbF₆⁻, from the standpoint of facilitating optimization of the leveling factor.

The leveling factor is the value represented by “leveling factor C=[recording layer thickness at groove DG (μm)−recording layer thickness at land section DI (μm)]/depth of groove A (μm)”. By optimizing the leveling factor it is possible to achieve a satisfactory balance between reflectance and modulation factor, for an excellent jitter property. The leveling factor C for DVD+R and DVD−R media is preferably 0.1 to 0.4, and more preferably 0.2 to 0.3. If the leveling factor is less than 0.1, a sufficient reflectance and modulation factor may not be achieved. If the leveling factor exceeds 0.4, jitter will tend to be increased and reflectance lowered. Including PF₆⁻ or SbF₆⁻ as an anion in the optical recording material will improve the fluidity of the coating solution used to form the optical recording material. This will help ensure satisfactory coverage of the recording layer from the land sections to the groove sections, thus reducing the difference between the thicknesses DG and DI.

The chelate compound is a metal chelate compound formed by coordination between a metal and an azo compound having an azo group substituted with an aromatic ring, and it is also referred to as “azo pigment” or “azo dye”. As examples of azo compound constituents for the chelate compound there may be mentioned compounds represented by the following general formula (20).
Ar¹—N═N—Ar² (20)

In formula (20), Ar¹ and Ar² may be groups composed of the same or different aromatic rings, and at least one thereof is an aromatic ring having a substituent capable of coordinating with metal atoms, or a nitrogen-containing heterocyclic aromatic ring having a nitrogen atom capable of coordinating with metal atoms. The substituent capable of coordinating with metal atoms or the nitrogen atom capable of coordinating with metal atoms is preferably at a position which allows coordination with the metal together with the azo group (for example, the ortho position in the case of a benzene ring).

The aromatic ring composing Ar¹ and Ar² may be a monocycle or a fused polycycle or bond-attached polycycle. As such aromatic rings there may be mentioned benzene ring, naphthalene ring, pyridine ring, thiazole ring, benzothiazole ring, oxazole ring, benzoxazole ring, quinoline ring, imidazole ring, pyrazine ring and pyrrole ring, among which benzene ring, pyridine ring, quinoline ring and thiazole ring are particularly preferred.

As substituents capable of coordinating with metal atoms there may be mentioned groups containing active hydrogen. As groups containing active hydrogen there may be mentioned —OH, —SH, —NH₂, —COOH, —CONH₂, —SO₂NH₂, —SO₃H and —NHSO₂CF₃, among which —OH is particularly preferred.

Ar¹ and Ar² may also have other substituents in addition to those mentioned above. The substituents of Ar¹ and Ar² may be the same or different, and when they are different, Ar¹ preferably has at least one selected from the group consisting of nitro, halogens (for example, chlorine or bromine), carboxyl, sulfo, sulfamoyl and alkyl (preferably C1-4, and more preferably methyl), while Ar² preferably has at least one selected from the group consisting of amino (preferably dialkylamino with a total of 2 to 8 carbon atoms, examples of which include dimethylamino, diethylamino, methylethylamino, methylpropylamino, dibutylamino and hydroxyethylmethylamino), alkoxy (preferably C1-4 alkoxy, such as methoxy), alkyl (preferably C1-4 alkyl, and more preferably methyl), aryl (preferably monocyclic, such as phenyl or chlorophenyl), carboxyl and sulfo. When Ar¹ is a benzene ring, the substituent thereof is preferably at the meta position or para position, and more preferably at the meta position, with respect to the azo group.

As metals (central metals) in the chelate compound there are preferred transition metals such as Co, Mn, Cr, Ti, V, Ni, Cu, Zn, Mo, W, Ru, Fe, Pd, Pt and Al. Alternatively, V, Mo and W may be present as their respective oxide ions, VO²⁺, VO³⁺, MoO²⁺, MoO³⁺, WO³⁺, etc. Particularly preferred among these are VO²⁺, VO³⁺, Co, Ni and Cu.

In the chelate compound, coordination bonds with the metal will usually be formed between the azo compound as a bidentate or tridentate ligand. When the azo compound has a substituent containing active hydrogens, the active hydrogens will generally dissociate to form the bidentate or tridentate ligand.

The chelate compound may be neutral, anionic or cationic as a whole. When the chelate compound is an anion, it will usually form a salt with its counter cation. As counter cations there may be mentioned metal cations such as Na⁺, Li⁺ and K⁺, or ammonium, tetraalkylammonium or the like. Alternatively, a salt may be formed with the trimethinecyanine dye cation as the counter cation.

As specific examples of chelate compounds there may be mentioned compounds A1 to A49 listed in Tables 7 to 12, any of which may be used alone or in various combinations. In the chelate compounds listed in Tables 7 to 12, two azo compounds are coordinated for each central metal element. Where the tables show two azo compounds or central metals they are in a 1:1 molar ratio, and where the central metal is shown as “V═O”, the azo compound is coordinated with acetylacetonevanadium. These chelate compounds may be obtained by syntheses according to publicly known methods (for example, see Furukawa, Anal. Chim. Acta., 140, p. 289, 1982).

TABLE 7

| | | Central |
|---|---|---|
| No. | Azo compound | metal |
| A1 | 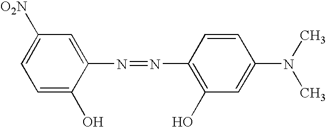 | Co |
| A2 | 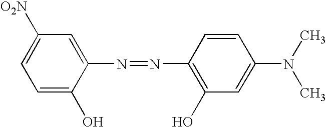 | V═O |
| A3 | 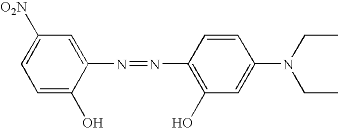 | Co |
| A4 | 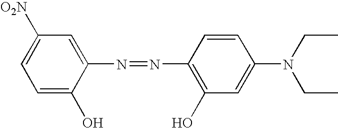 | V═O |
| A5 | 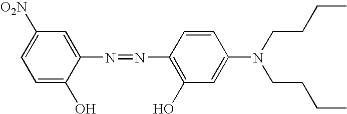 | Co |
| A6 | 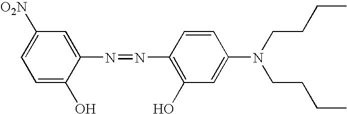 | V═O |
| A7 | 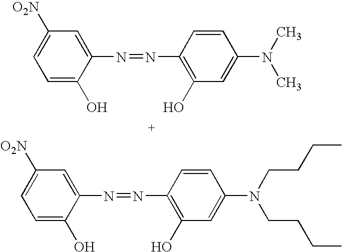 | Co |
| A8 | 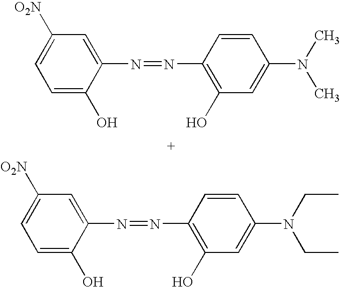 | Co |

TABLE 8

| | | Central |
|---|---|---|
| No. | Azo compound | metal |
| A9 | 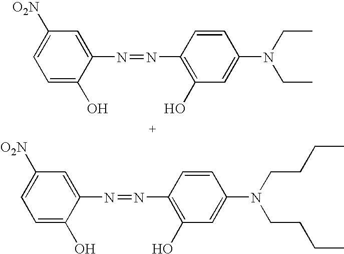 | Co |
| A10 | 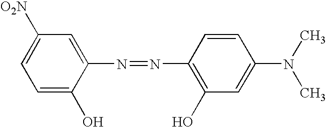 | Co +V═O |
| A11 | 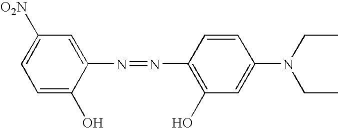 | Co +V═O |
| A12 | 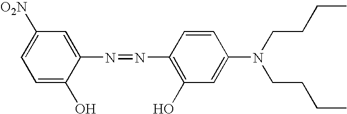 | Co +V═O |
| A13 | 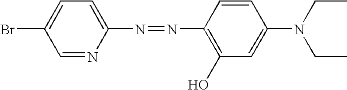 | Cu |
| A14 | 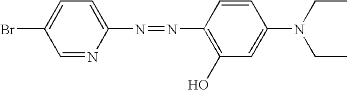 | Ni |
| A15 | 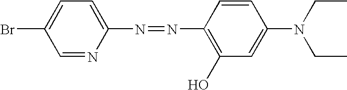 | Co |
| A16 | 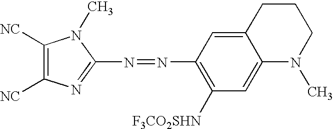 | Ni |
| A17 | 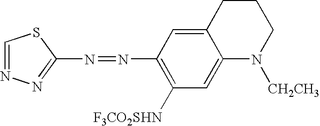 | Ni |

TABLE 9

| | | Central |
|---|---|---|
| No. | Azo compound | metal |
| A18 | 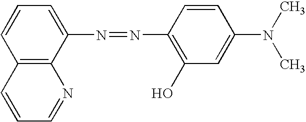 | Co |
| A19 | 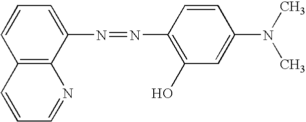 | Ni |
| A20 | 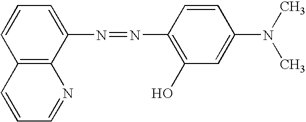 | Cu |
| A21 | 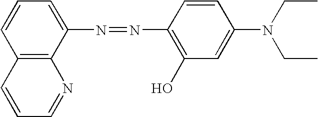 | Co |
| A22 | 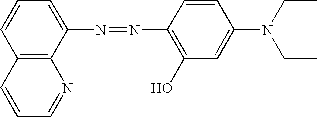 | Ni |
| A23 | 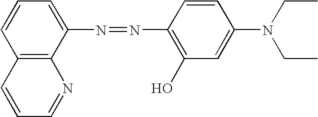 | Cu |
| A24 | 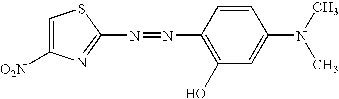 | Cu |
| A25 | 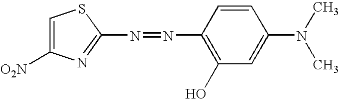 | Ni |
| A26 | 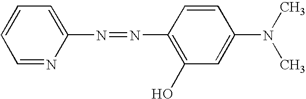 | Cu |
| A27 | 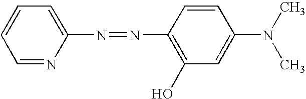 | Ni |

TABLE 10

| | | Central |
|---|---|---|
| No. | Azo compound | metal |
| A28 | 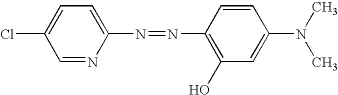 | Cu |
| A29 | 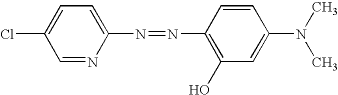 | Ni |
| A30 | 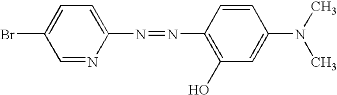 | Cu |
| A31 | 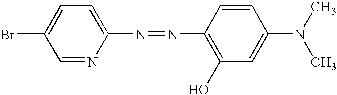 | Ni |
| A32 | 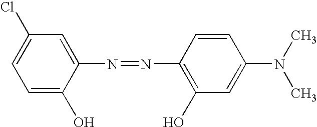 | Co |
| A33 | 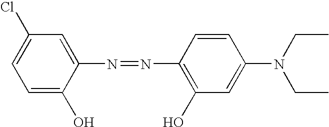 | Co |
| A34 | 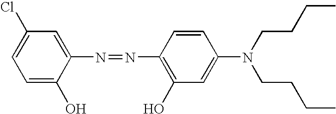 | Co |
| A35 | 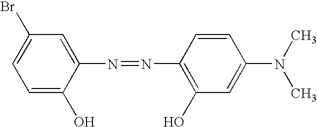 | Co |
| A36 | 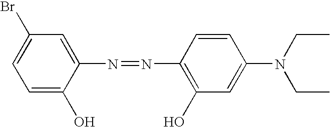 | Co |
| A37 | 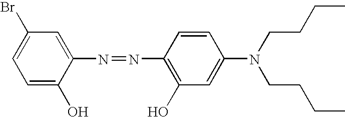 | Co |

TABLE 11

| No. | Azo compound | Central metal |
|---|---|---|
| A38 | 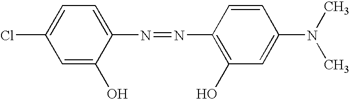 | Co |
| A39 | 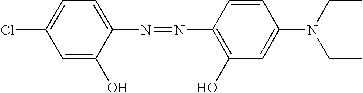 | Co |
| A40 | 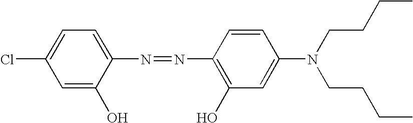 | Co |
| A41 | 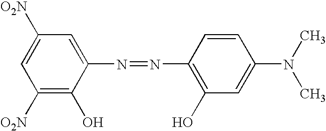 | Co |
| A42 | 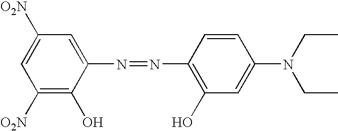 | Co |
| A43 | 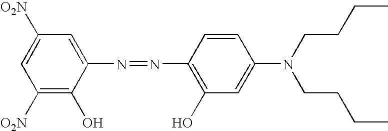 | Co |
| A44 | 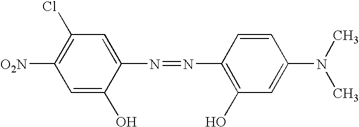 | Co |
| A45 | 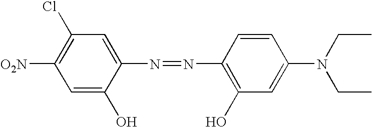 | Co |
| A46 | 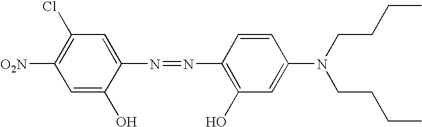 | Co |
| A47 | 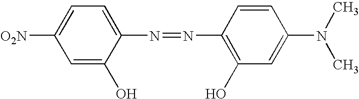 | Co |

TABLE 12

| No. | Azo compound | Central metal |
|---|---|---|
| A48 | 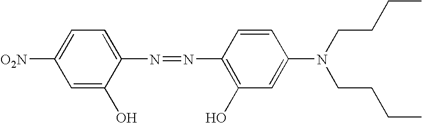 | Co |
| A49 | 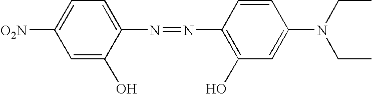 | Co |

The chelate compound content ratio is preferably 10 to 70 mole percent based on the total of the trimethinecyanine dye cation and the chelate compound. This will allow the light stability to be notably improved. This effect of improved light stability can be obtained when using either trimethinecyanine dye 1a or 1b, but a chelate compound content ratio in the aforementioned range is particularly effective from the standpoint of light stability when using trimethinecyanine dye cation 1a. The chelate compound content ratio is preferably 15 to 50 mole percent, and more preferably 20 to 30 mole percent. If the content ratio is less than 10 mole percent the light stability will tend to be insufficient, and if it is greater than 70 mole percent the degree of jitter will tend to be increased particularly in optical recording media with high recording speeds.

The optical recording material containing a trimethinecyanine dye cation and a chelate compound in the proportion explained above can be obtained by a method in which the chelate compound is mixed with a salt comprising the trimethinecyanine dye cation and its counter anion. When the chelate compound is an anion, the optical recording material may be obtained by forming a salt of the trimethinecyanine dye cation and the chelate compound anion (integrated salt). Alternatively, the aforementioned mixture may be used in the copresence of the integrated salt. Preparation of the mixture for obtaining the optical recording material is particularly easy and efficient, and is preferred from the standpoint of allowing a higher degree of freedom in selecting the dye.

The optical recording material preferably contains at least one kind of compound represented by formula (2) above (hereinafter also referred to as “added compound”). The total number of carbon atoms of such added compounds is preferably no greater than 20. If the total number of carbon atoms exceeds 20, the concentration of the dye in the optical recording material will be reduced when such added compounds are included in an equimolar ratio, as compared to a total number of carbon atoms of 20 or less, and this will tend to prevent achievement of sufficient sensitivity.

From the standpoint of sensitivity, it is more preferred for 3 or 4 of the X groups in the same molecule of the added compound to be C1-4 alkyl groups.

The content ratio of the added compound is preferably 0.5 to 50 mole percent based on the total of the trimethinecyanine dye cation and the added compound. If the content ratio is less than 0.5 mole percent the sensitivity will tend to be lowered, and if it is greater than 50 mole percent, deterioration of other materials adjacent to the recording layer in the optical recording medium, such as a silver reflective layer, will tend to be greater.

As examples of added compounds there may be mentioned amine compounds represented by general formula (3) below, ammonium compounds represented by general formulas (4) and (5) below, and phosphonium compounds represented by general formula (6) below, which may be suitably used either alone or in combinations. In formulas (3), (4), (5) and (6), X is optionally substituted alkyl or optionally substituted aryl.

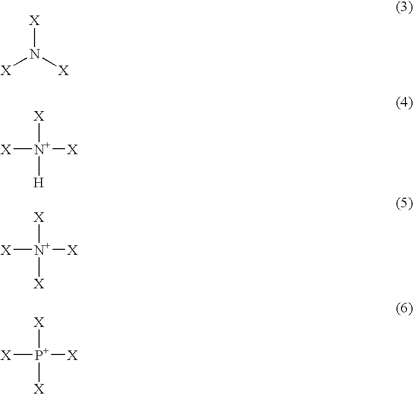

An amine compound represented by formula (3) may be used directly in admixture with the other constituent components of the optical recording material. An ammonium compound represented by formula (4) or (5), or a phosphonium compound represented by formula (6), will usually be combined with the other constituent components of the optical recording material in the form of salts with their counter anions. As examples of such counter anions there may be mentioned anions which are chelate compounds of the aforementioned azo compounds and metals. Including a chelate compound in the optical recording material will improve the light stability (light resistance) without notably lowering the sensitivity.

As added compounds there may be mentioned, more specifically, amine compound Nos. 301 to 306 listed in Table 13, ammonium compound Nos. 401 to 406 listed in Table 14 and Nos. 501 to 518 listed in Table 15, and phosphonium compound Nos. 601 to 612 listed in Table 16. Among these, the added compound preferably includes at least one selected from the group consisting of compounds represented by chemical formulas for Nos. 301 to 305, 401 to 403, 501 to 503 and 601 to 602 in Tables 13 to 16.

TABLE 13

| | |
|---|---|
| No. | X |

| | | | |
|---|---|---|---|
| 301 | —CH₃ | —CH₃ | —CH₃ |
| 302 | —CH₂CH₃ | —CH₂CH₃ | —CH₂CH₃ |
| 303 | —(CH₂)₂CH₃ | —(CH₂)₂CH₃ | —(CH₂)₂CH₃ |
| 304 | —(CH₂)₃CH₃ | —(CH₂)₃CH₃ | —(CH₂)₃CH₃ |
| 305 | —CH₃ | —CH₂CH₃ | —CH₂CH₃ |
| 306 | —CH₃ | —CH₂CH₃ | —CH₃ |

TABLE 14

| | |
|---|---|
| No. | X |

| | | | |
|---|---|---|---|
| 401 | —CH₃ | —CH₃ | —CH₃ |
| 402 | —CH₂CH₃ | —CH₂CH₃ | —CH₂CH₃ |
| 403 | —(CH₂)₂CH₃ | —(CH₂)₂CH₃ | —(CH₂)₂CH₃ |
| 404 | —(CH₂)₃CH₃ | —(CH₂)₃CH₃ | —(CH₂)₃CH₃ |
| 405 | —CH₃ | —CH₂CH₃ | —CH₂CH₃ |
| 406 | —CH₃ | —CH₂CH₃ | —CH₃ |

TABLE 15

| No. | X | | | |
|---|---|---|---|---|
| 501 | —CH₃ | —CH₃ | —CH₃ | —CH₃ |
| 502 | —CH₂CH₃ | —CH₂CH₃ | —CH₂CH₃ | —CH₂CH₃ |
| 503 | —CH₃ | —CH₂CH₃ | —CH₂CH₃ | —CH₂CH₃ |
| 504 | —CH₃ | —CH₃ | —CH₂CH₃ | —CH₃ |
| 505 | —(CH₂)₂CH₃ | —(CH₂)₂CH₃ | —(CH₂)₂CH₃ | —(CH₂)₂CH₃ |
| 506 | —CH₃ | —CH₃ | —(CH₂)₃CH₃ | —CH₃ |
| 507 | —CH₃ | —(CH₂)₂OH | —(CH₂)₂OH | —(CH₂)₂OH |
| 508 | —CH₃ | —(CH₂)₂OH | —CH₃ | —CH₃ |
| 509 | —CH₂CH₃ | —CH₂OH | —CH₂CH₃ | —CH₂CH₃ |
| 510 | —CH₃ | —(CH₂)₂OH | —(CH₂)₂OH | —CH₃ |
| 511 | —CH₂CH₃ | —(CH₂)₂OH | —CH₂CH₃ | —CH₂CH₃ |
| 512 | —CH₂CH₃ | —(CH₂)₂OH | —(CH₂)₂OH | —(CH₂)₂OH |
| 513 | —CH₃ | —(CH₂)₂O(CH₂)₂OH | —(CH₂)₂O(CH₂)₂OH | —(CH₂)₂O(CH₂)₂OH |
| 514 | —CH₂CH₃ | —CH₂CH₂Cl | —CH₂CH₃ | —CH₂CH₃ |
| 515 | —CH₂CH₃ | —CH₂CH₂F | —CH₂CH₂F | —CH₂CH₂F |
| 516 | —CH₃ | —(CH₂)₂CH₃ | —CH₃ | —CH₃ |
| 517 | —CH₃ | —CH₃ | —(CH₂)₄CH₃ | —CH₃ |
| 518 | —H | —H | —H | 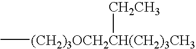 |

TABLE 16

| No. | X | | | |
|---|---|---|---|---|
| 601 | —CH₃ | —CH₃ | —CH₃ | —CH₃ |
| 602 | —CH₂CH₃ | —CH₂CH₃ | —CH₂CH₃ | —CH₂CH₃ |
| 603 | —CH₃ | —CH₂CH₃ | —CH₂CH₃ | —CH₂CH₃ |
| 604 | —CH₃ | —(CH₂)₂CH₃ | —CH₃ | —CH₃ |
| 605 | —(CH₂)₂CH₃ | —(CH₂)₂CH₃ | —(CH₂)₂CH₃ | —(CH₂)₂CH₃ |
| 606 | —CH₃ | —CH₃ | —(CH₂)₄CH₃ | —CH₃ |
| 607 | —CH₃ | —(CH₂)₂OH | —(CH₂)₂OH | —(CH₂)₂OH |
| 608 | —CH₃ | —(CH₂)₂OH | —CH₃ | —CH₃ |
| 609 | —CH₃ | —(CH₂)₄OH | —(CH₂)₂CH₃ | —CH₃ |
| 610 | —CH₂CH₃ | —(CH₂)₄OH | —CH₂CH₃ | —CH₂CH₃ |
| 611 | —CH₂CH₃ | —(CH₂)₂OH | —CH₂CH₃ | —CH₂CH₃ |
| 612 | —(CH₂)₂CH₃ | —(CH₂)₂OH | —(CH₂)₂OH | —(CH₂)₂OH |

The optical recording materials shown above may be suitably used to form the recording layer for an optical recording medium of the invention as explained below.

(Optical Recording Medium)

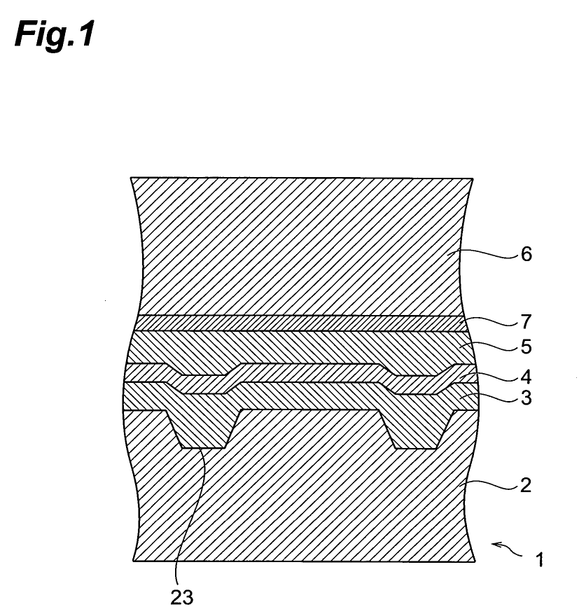

FIG. 1 is a partial cross-sectional view showing a preferred embodiment of an optical recording disc as an optical recording medium of the invention. The optical 10 recording disk 1 shown in FIG. 1 has a laminated structure wherein a recording layer 3, a reflective layer 4, a protective layer 5, an adhesive layer 7 and a base 6 are bonded together in that order on a base 2. The optical recording disk 1 is a write-once optical recording disk, capable of being recorded and read by light with a short wavelength of 630 to 685 nm.

The bases 2 and 6 are disk-shaped each with a diameter of about 64 to 200 mm and a thickness of about 0.6 mm, and writing and reading are accomplished from the back side of the base 2 (lower end of the drawing). Consequently, at least the base 2 is preferably one which is essentially transparent with respect to the recording light and reading light, and more specifically, the base 2 preferably has a transmittance of 88% or greater for the recording light and reading light. The material of the base 2 is preferably resin or glass which satisfies the necessary condition with regard to light transmittance, and most preferably it is a polycarbonate resin, acryl resin, amorphous polyolefin, TPX, polystyrene resin or another type of thermoplastic resin. On the other hand, there are no particular restrictions on the material for the base 6, and it may be the same material used for the base 2, for example.

The side of the base 2 on which the recording layer 3 is formed has a tracking groove 23 formed as a depression. The groove 23 is preferably a continuous spiral groove, with a thickness of 80 to 250 nm, a width of 200 to 500 nm and a groove pitch of 600 to 1000 nm. A groove with this construction will allow a satisfactory tracking signal to be obtained without reducing the reflection level of the groove. The groove 23 may be formed simultaneously with formation of the base 2 by extrusion molding using the aforementioned resin. Alternatively, a resin layer containing the groove 23 may be formed by the 2P method after manufacture of the base 2, whereby obtaining a composite base which comprises the base 2 and the resin layer.

The recording layer 3 is formed using the optical recording material of the invention mentioned above. The recording layer 3 may be formed by coating the base 2 with a mixed liquid obtained by dissolving or dispersing the optical recording material of the invention mentioned above in a solvent, and then removing the solvent from the coating. As solvents for the mixture there may be mentioned alcohol-based solvents (including keto alcohol-based or ethyleneglycol monoalkyl ether-based and other alkoxyalcohols), aliphatic hydrocarbon-based solvents, ketone-based solvents, ester-based solvents, ether-based solvents, aromatic-based solvents and halogenated alkyl-based solvents, among which alcohol-based solvents and aliphatic hydrocarbon-based solvents are preferred.

As alcohol-based solvents there are preferred alkoxy alcohols and keto alcohols. Alkoxy alcohol-based solvents preferably have C1-4 alkoxy portions, and C1-5 and more preferably C2-5 alcohol portions, with a total of 3-7 carbon atoms. Specifically, there may be mentioned ethyleneglycol monoalkyl ethers (cellosolves) such as ethyleneglycol monomethyl ether (methyl cellosolve), ethyleneglycol monoethyl ether (also known as ethyl cellosolve and ethoxyethanol), butylcellosolve and 2-isopropoxy-1-ethanol, or 1-methoxy-2-propanol, 1-methoxy-2-butanol, 3-methoxy-1-butanol, 4-methoxy-1-butanol and 1-ethoxy-2-propanol. As a keto alcohol there may be mentioned diacetone alcohol. Fluorinated alcohols such as 2,2,3,3-tetrafluoropropanol may also be used.

As aliphatic hydrocarbon-based solvents there are preferred n-hexane, cyclohexane, methylcyclohexane, ethylcyclohexane, cyclooctane, dimethylcyclohexane, n-octane, iso-propylcyclohexane and t-butylcyclohexane, among which ethylcyclohexane, dimethylcyclohexane and the like are especially preferred.

As a ketone-based solvent there may be mentioned cyclohexanone.

According to the invention, alkoxyalcohols such as ethyleneglycol monoalkyl ethers are preferred, and particularly ethyleneglycol monoethyl ether, 1-methoxy-2-propanol and 1-methoxy-2-butanol. The solvent used may be a single type, or it may be a mixed solvent of two or more types. For example, a mixed solvent of ethyleneglycol monoethyl ether and 1-methoxy-2-butanol is suitable for use.

The mixed liquid may also contain binders, dispersing agents, stabilizers and the like as appropriate, in addition to the components mentioned above.

As methods for coating the mixed liquid there may be mentioned spin coating, gravure coating, spray coating and dip coating, among which spin coating is preferred.

The thickness of the recording layer 3 formed in this manner is preferably 50 to 200 nm. In particular, a thickness of 70 to 150 nm is preferred because it will result in a satisfactory balance between modulation factor and reflectance. Outside of this range the reflectance will be lowered, tending to hamper reading. A thickness of the recording layer 3 of at least 200 nm at the section adjacent to the groove 23 will tend to disturb the balance between modulation factor and reflectance.

The extinction coefficient (imaginary part of the complex refractive index k) of the recording layer 3 for the recording light and reading light is preferably 0 to 0.20. If the extinction coefficient is greater than 0.20, sufficient reflectance may not be achieved. The refractive index (real part of the complex refractive index n) of the recording layer 3 is preferably at least 1.8. If the refractive index is less than 1.8, the modulation factor of the signal will tend to be smaller. The upper limit for the refractive index is not particularly restricted, but it will normally be about 2.6 for convenience of the organic dye synthesis.

The extinction coefficient and refractive index of the recording layer 3 may be determined according to the following procedure. First, a measurement sample is fabricated by forming a recording layer of about 40 to 100 nm on a prescribed transparent base, and then the reflectance through the measurement sample base or the reflectance from the recording layer side is measured. In this case, the reflectance is measured based on mirror reflection (about 50) using the wavelength of the recording and reading light. The light transmittance of the sample is also measured. The measured values are used to calculate the extinction coefficient and refractive index according to the method described in, for example, “Kogaku [Optics]”, K. Ishiguro, pp. 168-178, Kyoritsu Zensho Publishing.

A reflective layer 4 is provided on the recording layer 3 by bonding onto the recording layer 3. The reflective layer 4 may be formed by vapor deposition, sputtering or the like using a metal or alloy with high reflectance. As metals and alloys there may be mentioned gold (Au), copper (Cu), aluminum (Al), silver (Ag), AgCu and the like. The thickness of the reflective layer 4 formed in this manner is preferably 10 to 300 nm.

On the reflective layer 4 there is formed a protective layer 5 by bonding onto the reflective layer 4. The protective layer 5 may be in layer or sheet form. The protective layer 5 may be formed, for example, by coating the reflective layer 4 with a coating solution containing a material such as an ultraviolet curing resin and drying the coated solution if necessary. The coating may be accomplished by appropriate spin coating, gravure coating, spray coating, dip coating or the like. The thickness of the protective layer 5 formed in this manner is preferably 0.5 to 100 μm.

On the protective layer 5 there is formed a base 6 via an adhesive layer 7 on the protective layer 5. The base 6 may have the same material composition and thickness as the base 2. The adhesive layer 7 may be formed with the same material and by the same method as the adhesive layer 50 described hereunder.

During writing or reading of the optical recording disk 1 having this construction, recording light of a prescribed wavelength is irradiated in pulse form from the back side of the base 2 to vary the photoreflectance of the irradiated section. At this time, depending on the optical recording disk 1 on which the recording layer 3 comprising the trimethinecyanine dye cation and the chelate compound as the dye is formed, it is possible to achieve a good balance and high level of recording/reading properties (sensitivity and jitter) even when recording and reading of information is accomplished with high-speed rotation using short-wavelength recording and reading light.

The aforementioned embodiment was explained for an optical recording disk provided with a single recording layer 3 as the recording layer, but a plurality of recording layers may also be provided, with different dyes in each layer. This will allow recording and reading of information to be accomplished by a plurality of different recording and reading light beams with either the same or different wavelengths. In this case, a semi-transparent reflective film which is semi-transparent for the recording and reading light beams of each wavelength may be provided on the light-incident side and the opposite side of each recording layer.

The optical recording disk 1 obtained in this manner may also be used by attaching together two optical recording disks 1, or a single optical recording disk 1 and another optical recording disk having a different construction from the optical recording disk 1, with their light-incident sides (base 2 sides) facing outward.

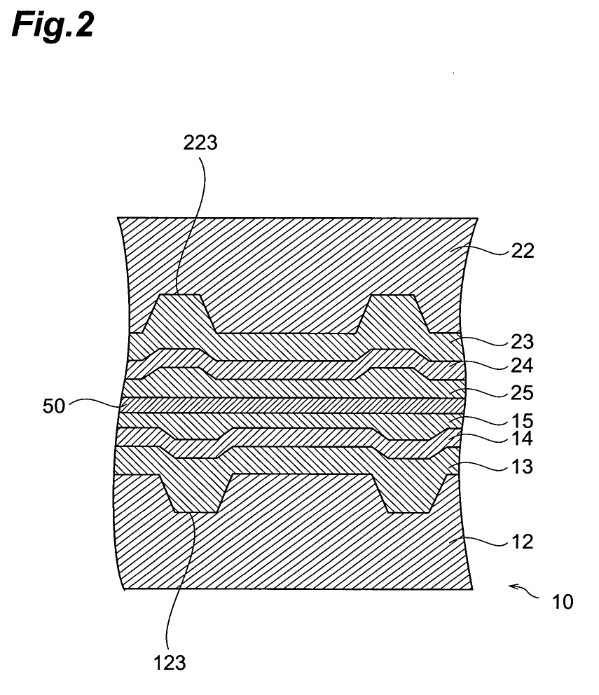

FIG. 2 is a partial cross-sectional view showing another preferred embodiment of an optical recording disc according to the attachment mode described above. The optical recording disk 10 shown in FIG. 2 has a laminated structure comprising a base 12, a recording layer 13, a reflective layer 14, a protective layer 15, an adhesive layer 50, a protective layer 25, a reflective layer 24, a recording layer 23 and a base 22 in that order on a base 2. That is, the optical recording disk 10 has a construction wherein two optical recording disks having the same construction as the optical recording disk 1 shown in FIG. 1 are attached together with their respective protective layers facing and sandwiching the adhesive layer 50. The optical recording disk 10 is a write-once digital video disk conforming to the DVD standard, whereby recording and reading are accomplished by light with a short wavelength of 650 to 670 nm.

The adhesive layer 50 used may be a hot-melt adhesive, ultraviolet curing adhesive, thermosetting adhesive, tacky adhesive or the like, and it may be formed by an appropriate method such as, for example, roll coating, screen printing, spin coating or the like. For a DVD−R, it is preferred to form the adhesive layer 50 by screen printing or spin coating using an ultraviolet curing adhesive, from the standpoint of balance between workability, productivity and disk characteristics. The thickness of the adhesive layer 50 is preferably about 10 to 200 μm.

The bases 12 and 22, the recording layers 13 and 23, the reflective layers 14 and 24 and the protective layers 15 and 25 are formed of the same materials and by the same method as for the optical recording disk 1 shown in FIG. 1. The thicknesses of the bases 12 and 22 are preferably about 0.6 mm. Grooves 123 and 223 are formed on the side of the base 12 on which the recording layer 13 is formed and on the side of the base 22 on which the recording layer 23 is formed, respectively. The grooves 123 and 223 preferably have depths of 60 to 200 nm, widths of 200 to 500 nm and groove pitches of 600 to 1000 nm. The thicknesses of the recording layers 13 and 23 are preferably 50 to 300 nm, and the complex refractive index for light of 650 nm is preferably n=1.8 to 2.6, k=0.00 to 0.10.

### EXAMPLES

The present invention will now be explained in greater detail through examples and comparative examples, with the understanding that these examples are in no way limitative on the invention.

### Example 1

On a polycarbonate resin base having a pre-groove (0.16 μm depth, 0.30 μm width, 0.74 μm groove pitch) formed on one side there was formed a recording layer (130 nm thickness) by coating and drying a mixed liquid which comprised an optical recording material prepared by mixing a chelate compound with a trimethinecyanine dye comprising a trimethinecyanine dye cation and its counter anion, in the combination and proportion shown in Table 17, dissolved in 2,2,3,3-tetrafluoropropanol to a content of 1.0 wt %. Next, an Ag reflective film (85 nm thickness) was formed on the recording layer by sputtering, and a transparent protective layer (5 μm thickness) composed of an ultraviolet curing acryl resin was formed on the Ag reflective layer to obtain a laminated structure. Two of these laminated structures were attached by an adhesive with their respective protective layers facing inward, to fabricate an optical recording disk having the same structure as the optical recording disk 10 shown in FIG. 2. The counter anion of the trimethinecyanine dye cation was PF₆⁻, and the counter cation of the chelate compound was Na⁺.

A signal was recorded on the obtained optical recording disk using laser light with a wavelength of 655 nm at a line speed of 3.5 m/s (corresponding to 1× speed) or 28.0 m/s (corresponding to 8× speed), and then the jitter was measured during reading using laser light with a wavelength of 650 nm at a line speed of 3.5 m/s. The lens aperture NA was 0.60. The obtained optical disk was irradiated (light exposure) for 40 hours using a 80,000 lux Xenon lamp (Xenon Fadeometer by Shimadzu Laboratories Co., Ltd.), and the jitter was measured in the same manner as above for the irradiated optical recording disk, for evaluation of the light stability. The evaluation results are shown in Table 17.

### Examples 2-22 and Comparative Examples 1-7

Optical recording disks were fabricated and evaluated in the same manner as Example 1, except that the mixtures in the combinations and proportions shown in Table 17 were used as optical recording materials. The Nos. listed for the trimethinecyanine dye cations and chelate compounds used in the optical recording materials correspond to the chemical structures of the Nos. shown in Tables 1 to 6 and Tables 7 to 12. The counter anion for the trimethinecyanine dye cations was PF₆⁻, and the counter cation for the chelate compounds was Na⁺. The compounds indicated by “*1” and “*2” in Table 18 were for optical recording materials prepared using salts (integrated salts) of trimethinecyanine dye cations and chelate compounds as described hereunder. For Comparative Examples 5, 6 and 7, the trimethinecyanine dye cation used was comparative compound A or B represented by chemical formula (7a) or (7b) below, wherein R¹, R², R³ and R⁴ in formula (1a) are all methyl. The evaluation results are shown in Tables 17 and 18.

For Examples 19-22 and Comparative Examples 6 and 7, the optical recording materials were prepared using salts of trimethinecyanine dye cations and chelate compound anions (1:1 molar ratio). In Example 20, for example, the optical recording material was prepared by mixing a salt of trimethinecyanine dye cation T26 and chelate compound A3 at 50 mole percent (i.e. A3 at 25 mole percent) and a salt of trimethinecyanine dye cation T26 and PF₆⁻ at 50 mole percent (total: 100 mole percent), for fabrication and evaluation of the optical recording disk.

TABLE 17

| | |
|---|---|
| | (7a) |
| 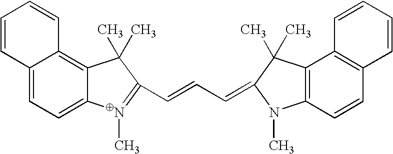 | |
| | (7b) |
| 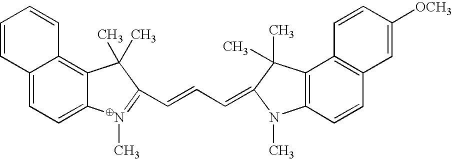 | |

| | | | | Jitter (%) | | | |
|---|---|---|---|---|---|---|---|
| | | Chelate compound | | Line speed 3.5 m/s | | Line speed 28.0 m/s | |
| | Trimethinecyanine | Azo | Content | Before | After light | Before | After light |
| | dye | compound | ratio | light | exposure | light | exposure |
| | Cation (No.) | (No.) | [mol %] | exposure | (light stability) | exposure | (light stability) |
| Example 1 | T1 | A1 | 40 | 7.1 | 7.8 | 7.2 | 7.5 |
| Example 2 | T2 | A14 | 20 | 6.5 | 7.1 | 6.9 | 7.8 |
| Example 3 | T5 | A18 | 50 | 7.2 | 7.4 | 7.6 | 8.0 |
| Example 4 | T7 | A13 | 70 | 7.9 | 7.9 | 7.6 | 8.1 |
| Example 5 | T9 | A32 | 40 | 7.2 | 7.9 | 7.9 | 8.0 |
| Example 6 | T11 | A35 | 50 | 7.1 | 7.5 | 6.8 | 7.1 |
| Example 7 | T12 | A24 | 30 | 6.7 | 7.2 | 7.1 | 7.6 |
| Example 8 | T21 | A9 | 10 | 6.7 | 8.3 | 7.0 | 8.1 |
| Example 9 | T22 | A11 | 55 | 7.4 | 7.9 | 6.9 | 7.1 |
| Example 10 | T24 | A17 | 50 | 7.0 | 7.6 | 7.1 | 7.4 |
| Example 11 | T26 | A27 | 45 | 7.2 | 7.9 | 7.3 | 7.9 |
| Example 12 | T32 | A23 | 70 | 7.6 | 8.1 | 8.1 | 8.3 |
| Example 13 | T35 | A21 | 40 | 7.2 | 8.2 | 7.5 | 7.5 |
| Example 14 | T46 | A16 | 10 | 7.1 | 8.2 | 7.1 | 8.1 |
| Example 15 | T49 | A22 | 20 | 7.0 | 7.4 | 6.9 | 7.4 |
| Example 16 | T51 | A4 | 40 | 7.4 | 8.1 | 7.5 | 7.9 |
| Example 17 | T53 | A3 | 60 | 7.2 | 7.7 | 7.4 | 7.5 |
| Example 18 | T63 | A7 | 50 | 7.1 | 8.1 | 7.4 | 7.9 |
| Comp. EX. 1 | T1 | — | — | 7.1 | unmeasurable | 6.7 | unmeasurable |
| Comp. EX. 2 | T1 | A15 | 5 | 7.4 | 15.2 | 7.3 | 15.1 |
| Comp. EX. 3 | T1 | A1 | 80 | 8.0 | 8.1 | 9.5 | 9.9 |
| Comp. Ex. 4 | — | A25 | 100 | 8.6 | 8.8 | 10.9 | 11.1 |
| Comp. EX. 5 | Comp. compound A | A1 | 40 | 8.1 | 8.5 | 9.1 | 9.2 |

TABLE 18

| | | | | Jitter (%) | | | |
|---|---|---|---|---|---|---|---|
| | | | | Line speed 3.5 m/s | | Line speed 28.0 m/s | |
| | | Chelate compound | | | After light | | After light |
| | | Azo | Content | Before | exposure | Before | exposure |
| | Trimethinecyanine dye | compound | ratio | light | (light | light | (light |
| | Cation (No.) | (No.) | [mol %] | exposure | stability) | exposure | stability) |
| Example 19 | T26*¹ | A3*² | 50 | 7.2 | 7.6 | 8.0 | 8.1 |
| Example 20 | T26*¹/T26 | A3*² | 25 | 7.0 | 7.9 | 7.1 | 7.4 |
| Example 21 | T26*¹/T53 | A3*² | 25 | 7.2 | 7.5 | 6.9 | 7.6 |
| Example 22 | T26*¹/T55 | A3*² | 30 | 7.2 | 7.4 | 6.8 | 7.4 |
| Comp. EX. 6 | Comp. compound B*¹ | A3*² | 50 | 8.1 | 8.5 | 14 | 14 |
| Comp. EX. 7 | Comp. compound B*¹ | A3*² | 25 | 8.7 | 8.9 | 9.4 | 9.8 |

*¹, *²Optical recording material prepared by mixing salt formed with trimethinecyanine dye and chelate compound (1:1 molar ratio).

As shown in Tables 17 and 18, Examples 1-22 exhibited a low degree of jitter and excellent light stability even with high-speed recording, as compared to Comparative Examples 1-7. Thus, it was confirmed that including trimethinecyanine dye cation 1a and a chelate compound in specific proportions can yield optical recording materials and optical recording media with satisfactory sensitivity and excellent jitter and light stability.

### Example 23

On a polycarbonate resin base having a pre-groove (0.16 μm depth, 0.30 μm width, 0.74 μm groove pitch) formed on one side there was formed a recording layer (130 nm thickness) by coating and drying a mixed liquid which comprised an optical recording material prepared by mixing a trimethinecyanine dye comprising a trimethinecyanine dye cation and PF₆⁻, with an additive in the combination shown in Table 19 and in a proportion such that the content ratio of the added compound was 10 wt % based on the total optical recording material, dissolved in 2,2,3,3-tetrafluoropropanol to a content ratio of 1.0 wt %. Next, an Ag reflective film (85 nm thickness) was formed on the recording layer by sputtering, and a transparent protective layer (5 μm thickness) composed of an ultraviolet curing acryl resin was formed on the Ag reflective layer to obtain a laminated structure. Two of these laminated structures were attached by an adhesive with their respective protective layers facing inward, to fabricate an optical recording disk having the same structure as the optical recording disk 10 shown in FIG. 2. In Table 19, the Nos. listed for the trimethinecyanine dye cations, added compounds and chelate compounds correspond to the chemical structures of the Nos. shown in Tables 1 to 6, Tables 13 to 16 and Tables 7 to 12. The chelate compounds were used to form salts with Na⁺ or the cations of the added compounds, and the salts were used to prepare the optical recording materials.

A signal was recorded on the obtained optical recording disk using laser light with a wavelength of 655 nm at a line speed of 28.0 m/s (corresponding to 8× speed), and then the optimum recording power P₀, as an index of the dye sensitivity, and the jitter, were measured during reading using laser light with a wavelength of 650 nm at a line speed of 3.5 m/s. The lens aperture NA was 0.60. The evaluation results are shown in Table 19.

### Examples 24-35 and Comparative Examples 8-9

Optical recording disks were fabricated and evaluated in the same manner as Example 1, except that the mixtures in the combinations and proportions shown in Table 19 were used as optical recording materials. The evaluation results are shown in Table 19. In Examples 26 and 27, salts of the chelate compounds and Na⁺ were mixed with the other materials, and in Examples 28-35, salts of the chelate compounds and an ammonium compound or phosphonium compound as an additive were mixed with the other materials, to prepare the respective optical recording materials. In Comparative Examples 8 and 9, the trimethinecyanine dye cation used was the comparative compound represented by chemical formula (7a) above, wherein R¹¹, R¹², R¹³ and R¹⁴ in formula (1b) are all methyl.

TABLE 19

| | | Chelate compound | | | | |
|---|---|---|---|---|---|---|
| | Trimethinecyanine | Azo | Content | | | |
| | dye | compound | ratio | Added | P₀ | Jitter |
| | Cation (No.) | (No.) | [mol %]* | compound | (mW) | (%) |
| Example 23 | T1 | — | — | 301 | 39.5 | 7.3 |
| Example 24 | T7 | — | — | 302 | 41.4 | 7.6 |
| Example 25 | T26 | — | — | 303 | 38.3 | 8.3 |
| Example 26 | T21 | A17 | 40 | 304 | 39.9 | 7.2 |
| Example 27 | T39 | A28 | 20 | 305 | 36.8 | 7.3 |
| Example 28 | T11 | A3 | —** | 401 | 40.2 | 6.9 |
| Example 29 | T24 | A7 | —** | 402 | 39.8 | 7.9 |
| Example 30 | T46 | A10 | —** | 403 | 39.4 | 8.1 |
| Example 31 | T51 | A12 | —** | 501 | 42.1 | 6.7 |
| Example 32 | T42 | A33 | —** | 502 | 40.4 | 8.2 |
| Example 33 | T12 | A37 | —** | 503 | 37.6 | 7.8 |
| Example 34 | T53 | A42 | —** | 601 | 41.5 | 7.4 |
| Example 35 | T60 | A48 | —** | 602 | 38.7 | 7.2 |
| Comp. EX. 8 | T1 | — | — | — | 45.7 | 7.7 |
| Comp. EX. 9 | Comparison | — | — | 301 | 41.5 | 9.7 |
| | compound | | | | | |

*Based on total of trimethinecyanine dye and chelate compound
**Added as a salt with the added compound

As shown in Table 19, Examples 23-35 exhibited satisfactory sensitivity (small P₀) without significant concomitant increase in jitter, compared to Comparative Examples 8 and 9. Thus, it was confirmed that including trimethinecyanine dye cation 1b, the aforementioned added compounds and chelate compounds can yield optical recording materials and optical recording media with sufficiently high sensitivity without a large increase in jitter.

According to the invention it is possible to obtain an optical recording medium with excellent jitter and light stability even under high recording speeds, as well as an optical recording material to be used for the medium. According to the invention it is also possible to obtain an optical recording medium which achieves sufficiently high sensitivity without significant concomitant increase in jitter, as well as an optical recording material to be used for the medium.

What is claimed is:

1. An optical recording material used in an optical recording medium capable of recording information by irradiation of light, which comprises
a cation represented by general formula (1a) below and
a chelate compound of an azo compound and a metal, the content ratio of said chelate compound being 10 to 70 mole percent based on the total of said cation and said chelate compound, 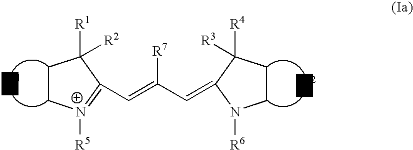
wherein
R¹ and R² each independently represent C1-4 alkyl or optionally substituted benzyl, or a group linked together to form a 3- to 6-membered ring,
R³ and R⁴ each independently represent C1-4 alkyl or optionally substituted benzyl, or a group linked together to form a 3- to 6-membered ring,
R⁵ and R⁶ each independently represent C1-4 alkyl or aryl, R⁷ represents hydrogen, a halogen, cyano, optionally substituted C1-4 alkyl or optionally substituted aryl and
Q¹ and Q² each independently represent a group of atoms constituting an optionally substituted benzene ring or an optionally substituted naphthalene ring,
with the proviso that at least one from among R¹, R², R³ and R⁴ is a non-methyl group.

2. An optical recording material according to claim 1, which is obtained by mixing a salt of said cation and its counter anion with said chelate compound.

3. An optical recording material used in an optical recording medium capable of recording information by irradiation of light, which comprises
a cation represented by general formula (1b) below,
a chelate compound of an azo compound and a metal, and
a compound represented by general formula (2) below, 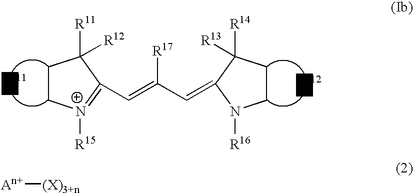
wherein
R¹¹, R¹², R¹³, R¹⁴, R¹⁵ and R¹⁶ each independently represent optionally substituted C1-4 alkyl or optionally substituted aryl,
R¹⁷ represents hydrogen, a halogen, cyano, optionally substituted C1-4 alkyl or optionally substituted aryl,
Q¹¹ and Q¹² each independently represent a group of atoms constituting an optionally substituted aromatic ring,
A represents a nitrogen or phosphorus atom,
X represents hydrogen, optionally substituted C1-4 alkyl or optionally substituted aryl and
n represents 0 or 1,
with the proviso that R¹¹ and R¹² or R¹³ and R¹⁴ may be linked together as a group forming a cyclic structure, at least one from among R¹¹, R¹², R¹³ and R¹⁴ is a non-methyl group, and multiple X groups in the same molecule may be the same or different, with at least one of the X groups in the same molecule representing optionally substituted C1-4 alkyl or optionally substituted aryl.

4. An optical recording material according to claim 3,
wherein the total number of carbon atoms of said compound represented by general formula (2) is no greater than 20.

5. An optical recording material according to claim 3,
wherein
R¹¹ and R¹² each independently represent C1-4 alkyl or optionally substituted benzyl, or a group linked together to form a 3- to 6-membered ring,
R¹³ and R¹⁴ each independently represent C1-4 alkyl or optionally substituted benzyl, or a group linked together to form a 3- to 6-membered ring,
R¹⁵ and R¹⁶ each independently represent C1-4 alkyl or aryl, and
Q¹¹ and Q¹² each independently represent a group of atoms constituting an optionally substituted benzene ring or an optionally substituted naphthalene ring.

6. An optical recording material according to claim 4,
wherein R¹¹ and R¹² each independently represent C1-4 alkyl or optionally substituted benzyl, or a group linked together to form a 3- to 6-membered ring,
R¹³ and R¹⁴ each independently represent C1-4 alkyl or optionally substituted benzyl, or a group linked together to form a 3- to 6-membered ring,
R¹⁵ and R¹⁶ each independently represent C1-4 alkyl or aryl, and
Q¹¹ and Q¹² each independently represent a group of atoms constituting an optionally substituted benzene ring or an optionally substituted naphthalene ring.

7. An optical recording material according to claim 3, which comprises PF₆⁻ or SbF₆⁻.

8. An optical recording material according to claim 4, which comprises PF₆⁻ or SbF₆⁻.

9. An optical recording material according to claim 5, which comprises PF₆⁻ or SbF₆⁻.

10. An optical recording material according to claim 6, which comprises PF₆⁻ or SbF₆⁻.

11. An optical recording medium capable of recording information by irradiation of light, which includes a recording layer comprising
a cation represented by general formula (1a) below and
a chelate compound of an azo compound and a metal,
the content ratio of said chelate compound being 10 to 70 mole percent based on the total of said cation and said chelate compound, 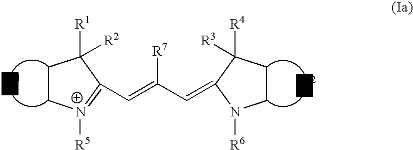
wherein
R¹ and R² each independently represent C1-4 alkyl or optionally substituted benzyl, or a group linked together to form a 3- to 6-membered ring,
R³ and R⁴ each independently represent C1-4 alkyl or optionally substituted benzyl, or a group linked together to form a 3- to 6-membered ring,
R⁵ and R⁶ each independently represent C1-4 alkyl or aryl,
R⁷ represents hydrogen, a halogen, cyano, optionally substituted C1-4 alkyl or optionally substituted aryl and
Q¹ and Q² each independently represent a group of atoms constituting an optionally substituted benzene ring or an optionally substituted naphthalene ring,
with the proviso that at least one from among R¹, R², R³ and R⁴ is a non-methyl group.

12. An optical recording medium according to claim 11,
wherein said recording layer comprises a mixture obtained by mixing a salt of said cation and its counter anion with said chelate compound.

13. An optical recording medium capable of recording information by irradiation of light, which includes a recording layer comprising
a cation represented by general formula (1b) below,
a chelate compound of an azo compound and a metal, and
a compound represented by general formula (2) below, 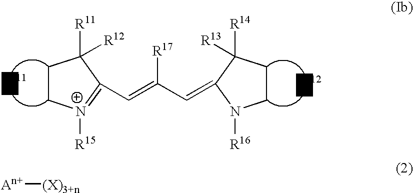
wherein
R¹¹, R¹², R¹³, R¹⁴, R¹⁵ and R¹⁶ each independently represent optionally substituted C1-4 alkyl or optionally substituted aryl,
R¹⁷ represents hydrogen, a halogen, cyano, optionally substituted C1-4 alkyl or optionally substituted aryl,
Q¹¹ and Q¹² each independently represent a group of atoms constituting an optionally substituted aromatic ring,
A represents a nitrogen or phosphorus atom,
X represents hydrogen, optionally substituted C1-4 alkyl or optionally substituted aryl and
n represents 0 or 1,
with the proviso that R¹¹ and R¹² or R¹³ and R¹⁴ may be linked together as a group forming a cyclic structure, at least one from among R¹¹, R¹², R¹³ and R¹⁴ is a non-methyl group, and multiple X groups in the same molecule may be the same or different, with at least one of the X groups in the same molecule representing optionally substituted C1-4 alkyl or optionally substituted aryl.

14. An optical recording medium according to claim 13,
wherein the total number of carbon atoms of said compound represented by general formula (2) is no greater than 20.

15. An optical recording medium according to claim 13,
wherein
R¹¹ and R¹² each independently represent C1-4 alkyl or optionally substituted benzyl, or a group linked together to form a 3- to 6-membered ring,
R¹³ and R¹⁴ each independently represent C1-4 alkyl or optionally substituted benzyl, or a group linked together to form a 3- to 6-membered ring,
R¹⁵ and R¹⁶ each independently represent C1-4 alkyl or aryl, and
Q¹¹ and Q¹² each independently represent a group of atoms constituting an optionally substituted benzene ring or an optionally substituted naphthalene ring.

16. An optical recording medium according to claim 14,
wherein
R¹¹ and R¹² each independently represent C1-4 alkyl or optionally substituted benzyl, or a group linked together to form a 3- to 6-membered ring,
R¹³ and R¹⁴ each independently represent C1-4 alkyl or optionally substituted benzyl, or a group linked together to form a 3- to 6-membered ring,
R¹⁵ and R¹⁶ each independently represent C1-4 alkyl or aryl, and
Q¹¹ and Q¹² each independently represent a group of atoms constituting an optionally substituted benzene ring or an optionally substituted naphthalene ring.

17. An optical recording medium according to claim 13, wherein said recording layer comprises PF₆⁻ or SbF₆⁻.

18. An optical recording medium according to claim 14, wherein said recording layer comprises PF₆⁻ or SbF₆⁻.

19. An optical recording medium according to claim 15, wherein said recording layer comprises PF₆⁻ or SbF₆⁻.

20. An optical recording medium according to claim 16, wherein said recording layer comprises PF₆⁻ or SbF₆.
